(19) United States
(12) Patent Application Publication
(10) Pub. No.: US 2011/0109661 A1
(43) Pub. Date: May 12, 2011

(54) LUMINANCE CORRECTION SYSTEM AND LUMINANCE CORRECTION METHOD USING THE SAME

(76) Inventor: In-Soo Lee, Yongin-City (KR)

(21) Appl. No.: 12/890,567

(22) Filed: Sep. 24, 2010

(30) Foreign Application Priority Data
Nov. 12, 2009 (KR) 10-2009-0109020

(51) Int. Cl. G09G 5/10

(52) U.S. Cl. 345/690

(57) ABSTRACT

A luminance correction system comprises: a data applying unit coupled to a panel of the flat panel display, and configured to apply data including center gamma value information according to a selected luminance mode to the panel; an image analyzing unit configured to analyze an image displayed on the panel according to the data and output at least one analyzed result; an offset value setting unit coupled to the image analyzing unit, and configured to generate a reference offset value corresponding to a center gamma value for a reference luminance and the at least one analyzed result, and to generate an additional offset value corresponding to the second luminance mode and the at least one analyzed result when a second luminance mode is selected; and a data adjusting unit coupled to the offset value setting unit, and configured to adjust the data according to the reference offset value and supply the adjusted data to the data applying unit.

### CROSS-REFERENCE TO RELATED APPLICATIONS

This application claims priority to and the benefit of Korean Patent Application No. 10-2009-0109020, filed on Nov. 12, 2009, in the Korean Intellectual Property Office, the entire content of which is incorporated herein by reference.

### BACKGROUND

1. Field

Aspects of embodiments according to the present invention relate to a luminance correction system and a luminance correction method using the same particularly a luminance correction system of a flat panel display using a multi-luminance system and a luminance correction method using the luminance correction system.

2. Description of Related Art

A variety of flat panel displays which are lighter and smaller than cathode ray tubes, have been recently developed. Various flat panel displays include liquid crystal display devices (LCDs) and organic light emitting display devices (OLEDs), etc.

In general, flat panel displays, such as LCDs and OLEDs, create data signals having voltage levels in accordance with each gray level from a reference gamma value, and correspondingly display images.

However, differences in the manufacturing process of the flat panel displays can cause the luminance of a completed product to be different than a desired luminance. When the luminance of a product is different from the desired luminance, the product is considered a poor product, and the product's luminance must be corrected even in a completed flat panel display.

### SUMMARY

Accordingly, an aspect of the present invention provides a luminance correction method and system that can effectively correct the luminance and color coordinates of a flat panel display which employs a multi-luminance system.

According to one embodiment, a luminance correction system for a flat panel display is provided. The luminance correction system includes: a data applying unit coupled to a panel of the flat panel display, and configured to apply data including center gamma value information according to a selected luminance mode from among a plurality of luminance modes to the panel; an image analyzing unit configured to analyze an image displayed on the panel according to the data and output at least one analyzed result; an offset value setting unit coupled to the image analyzing unit, and configured to generate a reference offset value corresponding to a center gamma value for a reference luminance mode from among the luminance modes and the at least one analyzed result, and to generate an additional offset value corresponding to the second luminance mode and the at least one analyzed result when a second luminance mode is selected from among the luminance modes; and a data adjusting unit coupled to the offset value setting unit, and configured to adjust the data according to the reference offset value and to supply the adjusted data to the data applying unit.

The data adjusting unit may be further configured to adjust the data according to the reference offset value, the additional offset value, and a center gamma value for the second luminance mode when the second luminance mode is selected

Further, the data applying unit may be further configured to apply gray level data at a breakpoint of a luminance curve according to the gray level, together with the center gamma value information, to the panel. Then the data applying unit may also be further configured to apply data corresponding to a highest gray level to the panel such that the panel emits light having a highest luminance.

The image analyzing unit may include: a measuring unit configured to measure a chromaticity and a luminance of the image; a color coordinates determining unit configured to generate color coordinates according to the measured chromaticity; and a luminance comparing unit configured to generate a luminance difference according to a reference luminance and the measured luminance.

The offset value setting unit may be configured to generate a luminance offset value according to the luminance difference and a color coordinates offset value according to the color coordinates.

The data adjusting unit may be further configured to correct the luminance by adjusting a gamma value according to the reference offset value. And the image analyzing unit may be further configured to analyze the chromaticity of the image after a luminance corrected image is displayed by the panel in accordance with the offset value corresponding to the analyzed result of the image.

According to one embodiment, a storing unit may be configured to store the reference offset value and the additional offset value. Further, the storing unit may also be configured to store the amount of luminance change corresponding to the result of analyzing the image.

According to another aspect of the embodiment, there is provided a luminance correction method including: applying data including center gamma value information for a first luminance mode to a panel of a flat panel display; analyzing an image displayed on the panel and setting a reference offset value according to the analyzed result; correcting a luminance and a chromaticity of the data in the first luminance mode according to the center gamma value for the first luminance mode and the reference offset value; changing a center gamma value for a second luminance mode and applying data including the changed center gamma value to the panel; analyzing an image displayed on the panel and setting an additional offset value for the second luminance mode according to the analyzed result; and correcting a luminance and a chromaticity of the data in the second luminance mode according to the center gamma value for the second luminance mode, the reference value, and the additional offset value.

The data applied to the panel may include gray level data information at a breakpoint appearing in a luminance curve, together with the center gamma value information for the first or second luminance mode.

The setting of a reference offset value may include: measuring the luminance of the image and setting a reference offset value for the luminance; measuring the luminance of the image after correcting the luminance, using the reference offset value for the luminance; and determining color coordinates on according to the measured chromaticity and setting a reference offset value for the color coordinates.

The setting of the reference offset value for the luminance may include: comparing measured luminance of an image with a reference luminance; and setting a reference offset value for luminance on the basis of the compared result.

The setting a reference offset value for the color coordinates may include: selecting one case from a plurality of cases on the basis of a desired white color coordinates for the determined coordinates; and setting a reference offset value for the color coordinates on the basis of the selected case.

The setting of an additional offset value may include: measuring the luminance of the image and setting an additional offset value for the luminance; measuring chromaticity of the image after correcting the luminance, using the additional offset value for the luminance and the reference offset value; and determining color coordinates on the basis of the measured chromaticity and setting an additional offset value for the color coordinates.

According to another embodiment it is possible to effectively correct the luminance and the color coordinates of a flat panel display employing a multi-luminance system, for each luminance mode, by accurately correcting the luminance, and by further applying an additional offset value when changing the luminance mode. Therefore, it is possible to display an image having improved quality while satisfying the customer's demands.

These and other features, aspects, and embodiments are described below in the section entitled “Detailed Description.”

### BRIEF DESCRIPTION OF THE DRAWINGS

The above and other aspects and features of the embodiments according to the present invention will be more clearly understood from the following detailed description taken in conjunction with the accompanying drawings, in which:

FIG. 1 is a plan view illustrating an example of a flat panel display to illustrate an embodiment of the present invention;

FIG. 2 is a block diagram illustrating a luminance correction system according to an embodiment of the present invention;

FIG. 3 is a graph showing color coordinates; and

FIG. 4 is a block diagram illustrating a luminance correction method using the luminance correction system shown in FIG. 2, by stages.

### DETAILED DESCRIPTION

Hereinafter, certain exemplary embodiments according to the present invention will be described with reference to the accompanying drawings. Here, when a first element is described as being coupled to a second element, the first element may be directly coupled to the second element or may also be indirectly coupled to the second element via a third element. Further, some of the elements that are not essential to a complete understanding of the invention are omitted for clarity. Also, like reference numerals refer to like elements throughout.

When only the luminance of a flat panel display is corrected, the white balance may be distorted by the efficiency difference between the red pixel, the green pixel, and the green pixel. Therefore, it is preferable to correct the color coordinates as well as the luminance to overcome this problem.

A multi-luminance system is a luminance system which has a plurality of luminance modes to generally change the luminance of an image, e.g., based on a user's preference or the viewing environment. For example, a luminance system may change the luminance in accordance with three luminance modes, such as: a reference luminance mode, a low luminance mode, and a power-saving mode. Therefore, to correct for inaccurate luminances in a multi-luminance display, a luminance correction method should effectively correct the luminance and color coordinates in accordance with each luminance mode.

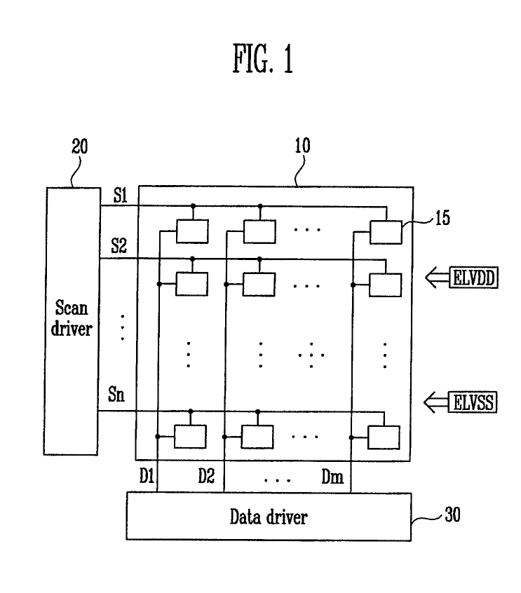

FIG. 1 is a plan view illustrating a flat panel display according to one embodiment of the present invention.

Referring to FIG. 1, a display device (e.g., an organic light emitting display device) according to an embodiment of the present invention includes a display unit 10, a scan driver 20, and a data driver 30.

The display unit 10 includes a plurality of pixels 15 located in a matrix at crossings of scanning lines S1 to Sn and data lines D1 to Dm, and is activated by supplying power from a high potential pixel power source ELVDD and a low potential pixel power source ELVSS.

Each of the pixels 15 in the display unit 10 stores a data signal supplied from a data line D when a scanning signal is supplied from a scanning line S, and emits light having luminance corresponding to the data signal. Therefore, an image corresponding to the data signals is displayed on the display unit 10.

The scan driver 20 sequentially generates scanning signals in response to scanning control signals that are supplied from the outside (e.g., from a timing control unit). The scanning signals created by the scan driver 20 are supplied to the pixels 15 through the scanning lines S1 to Sn.

The data driver 30 generates data signals in response to data and data control signals which are supplied from the outside (e.g. from the timing control unit). The data signals created by the data driver 30 are supplied to the pixels 15 through the data lines D1 to Dm in synchronization with the scanning signals.

The data driver 30 generates data signals having voltage levels according to gray levels of the data based on predetermined gamma values, but images having different luminance can be displayed in different panels for the same data signals. This variation of luminance values can occur in the panels due to differences in the manufacturing process. Therefore, it is desirable to correct measured luminance of a product to fit desired value, even in a completed flat panel display.

Further, it is possible to change the luminance by changing the center gamma value. In a flat panel display that employs a multi-luminance system that can generally change the luminance of an image by applying a plurality of luminance modes in accordance with the user's various demands, if the luminance is corrected only on the basis of a luminance correction value with respect to a reference luminance mode, the accuracy of correction may be reduced, such as that the correction value is distorted, and as a result, the image quality may be deteriorated.

Therefore, in embodiments according to the present invention a luminance correction system that can effectively correct the luminance and the color coordinates of a flat panel display employing a multi-luminance system. Also provided is a luminance correction method using the luminance correction system. The luminance correction system and method are described in detail below.

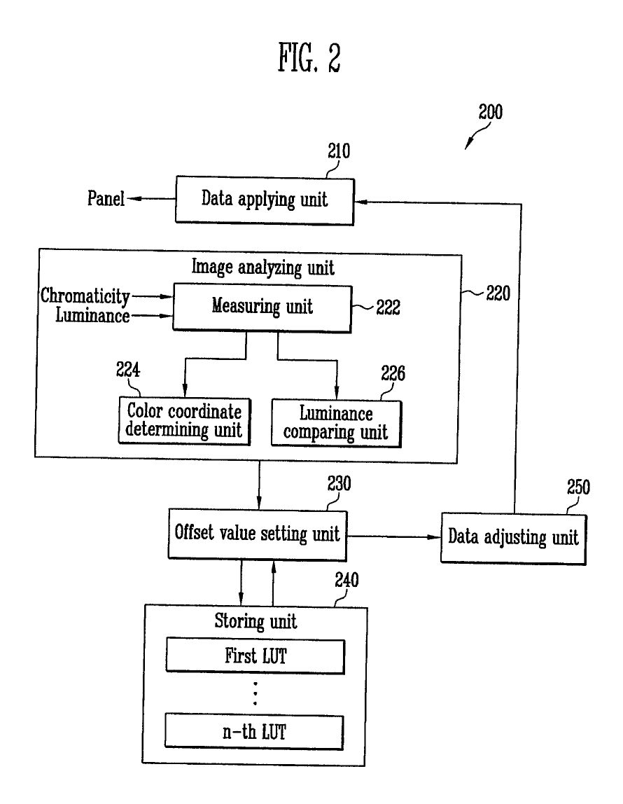

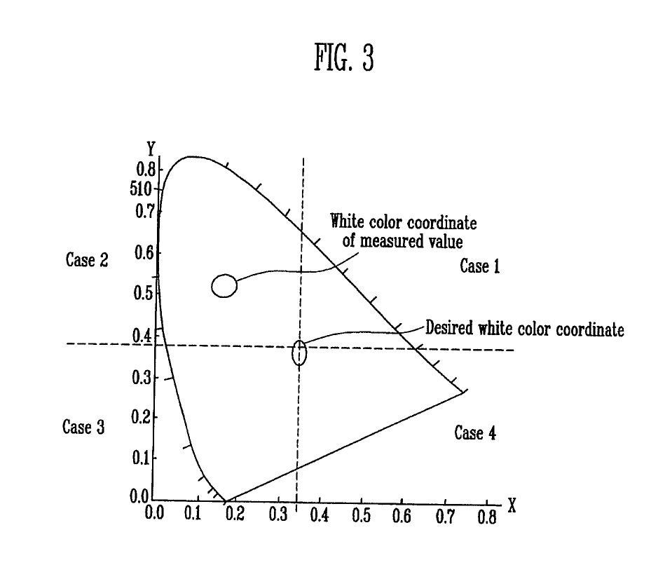

FIG. 2 is a block diagram illustrating a luminance correction system according to an embodiment of the present invention. FIG. 3 is a graph showing color coordinates.

First, referring to FIG. 2, a luminance correction system 200 according to an embodiment of the present invention can be used to correct the luminance of a flat panel display employing a multi-luminance system, and includes a data applying unit 210, an image analyzing unit 220, an offset value setting unit 230, a storing unit 240, and a data adjusting unit 250. The luminance correction system 200, for example, may be included in the data drive 30 of FIG. 1.

The data applying unit 210 applies data including center gamma value information according to a luminance mode selected from a plurality of luminance modes to the panel (e.g., display unit of FIG. 1) of a flat panel display.

For example, the plurality of luminance modes may be set into a reference luminance mode having the maximum luminance of 200 cd/m², a low luminance mode having the maximum luminance of 50 cd/m², and a power-saving mode having the maximum luminance of 25 cd/m². In this case, the data applying unit 210 can apply data, which corresponds to a luminance mode selected from the luminance modes in accordance with user's selection or the use environment (e.g., viewing environment), to the panel. The panel displays an image corresponding to the data transmitted from the data applying unit 210.

The data applied from the data applying unit 210 to the panel includes center gamma value information corresponding to the selected luminance mode, and may include offset value information as well as the center gamma value information after one or more offset values for luminance correction are determined. For example, the sum of the center gamma value and the offset value may be outputted from the data applying unit 210.

In particular, in the process of luminance correction, the data applying unit 210 can apply the maximum gray level allowing the panel to emit light having the maximum luminance, e.g., data of 63 gray level with the center gamma value to the panel. That is, the luminance correction can be performed while the full-white is displayed in an image, in which the data applying unit 210 can apply data of the maximum gray level where the center gamma value is applied, to the panel.

Further, the panel applying unit 210 further applies different gray level data at a breakpoint appearing in a luminance curve according to the gray level, e.g., 31-gray level with data of the maximum gray level to the panel. In this case, image analysis for a plurality of gray levels can be performed, such that the accuracy in luminance correction can be increased.

The image analyzing unit 220 analyzes the image displayed on the panel in response to data transmitted from the data applying unit 210, and outputs the analyzed result. For example, the image analyzing unit 220 can analyze the luminance and chromaticity and output the analyzed result.

In order to achieve this operation, the image analyzing unit 220 may include a measuring unit 222 that measures the chromaticity and luminance of an image, a color coordinates determining unit 224 that determines the color coordinates according to the measured chromaticity, and a luminance comparing unit 226 that finds a luminance difference between a predetermined desired luminance and the measured luminance.

The offset value setting unit 230 sets an offset value on the basis of the result of analyzing an image. In more detail, the offset value setting unit 230 can set a luminance offset value to adjust luminance corresponding to a luminance difference obtained by the luminance comparing unit 226 and a color coordinates offset value for adjusting chromaticity according to the color coordinates obtained by the color coordinates determining unit 224.

For example, the offset value setting unit 230 sets a gamma adjustment value, which makes it possible to compensate a luminance difference between the desired luminance and the measured luminance, as a luminance offset value, and can set a color coordinates movement value, which makes it possible to correct the color coordinates distorted by problems in luminance correction or the process, as a color coordinates offset value.

In this operation, the offset value setting unit 230 can extract an offset value corresponding to the luminance difference and the color coordinates from a lookup table stored in the storing unit 240, a graph, or from a formula (e.g., a predetermined formula).

The storing unit 240 stores an offset value set by the offset value setting unit 230. Additionally, the storing unit 240 can be further configured to store offset values corresponding to various luminance differences and color coordinates to allow the offset value setting unit 230 to refer to them. For example, the storing unit can further store the amount of luminance change corresponding to the result of analyzing an image.

The data adjusting unit 250 adjusts data for display on the basis of an offset value set by the offset value setting unit 230, and then supplies the adjusted data to the data applying unit 210.

For example, the data adjusting unit 250 may be configured to correct luminance by adjusting the gamma value on the basis of the luminance offset value. For example, the data adjusting unit may correct luminance by adjusting a gamma value using the sum of the center gamma value and the luminance offset value. That is, the luminance correction value may be set as the gamma value.

The luminance offset value may be set as a negative value to reduce luminance when the measured luminance is higher than the desired luminance, or it may be a positive value to increase the luminance when the measured luminance is lower than the desired luminance.

Further, the data adjusting unit 250 may correct the chromaticity by adjusting the color coordinates and using the color coordinates offset value.

The chromaticity correction may be performed concurrently (e.g., simultaneously) with luminance correction on the basis of the result of analyzing an image. Alternatively, it may be performed by first adjusting the luminance, and then reanalyzing the luminance corrected image and correcting the color coordinates. In this case, it is possible to correct even the color coordinates distorted by luminance correction, such that it is possible to effectively correct characteristic differences between panels.

According to an embodiment, the luminance correction may be performed not only in the reference luminance mode, but also in a plurality of luminance modes (e.g., each of the luminance modes of the display device).

In particular, according to one embodiment, it is possible to more accurately correct luminance by further applying an additional offset value for luminance modes other than the reference luminance mode. Accordingly, it is possible to display an image having improved quality while satisfying various demands of customers, by effectively correcting the luminance and the color coordinates of a flat panel display employing a multi-luminance system, for each luminance mode.

For example, the luminance correction system 200 according to one embodiment displays an image in accordance with a center gamma value according to a predetermined reference luminance mode (e.g., a first luminance mode, or a predetermined reference luminance mode) in a plurality of luminance modes, set a reference offset value, analyzes the image by applying data, which is obtained by applying the reference offset value to the center gamma value according to another luminance mode (e.g., low luminance mode or power-saving mode; second luminance mode), to the panel, and then sets an additional offset value for the second luminance mode. The reference offset value and the additional offset value can be stored in the storing unit 240. In order to achieve this operation, the storing unit 240 may have a lookup table, for example, first to n-th (n is a natural number greater than 2) LUTs.

The following formulas 1 and 2 can be obtained by exemplifying a luminance correction value of the first luminance mode having the maximum luminance of 200 cd/m² and the second luminance mode having the maximum luminance of 25 cd/m².

first luminance correction value(200 cd/m² reference)=center gamma value(200 cd/m² reference)+reference offset value(200 cd/m²) Formula 1

second luminance correction value(25 cd/m² reference)=center gamma value(25 cd/m² reference)+reference offset value(200 cd/m²)+additional offset value(25 cd/m² reference) Formula 2

That is, when the second luminance mode is selected, it is possible to adjust the data that is supplied to the panel by calculating the center gamma value for the second luminance value, the reference offset value obtained in the first luminance mode, and the additional offset value for the second luminance mode.

The center gamma value may be an ideal gamma value that is predetermined in accordance with each luminance mode without considering characteristic differences between the panels, but as described above, it is possible to manufacture flat panel displays having uniform image quality by applying the offset value to compensate characteristic differences of the panels.

On the other hand, although only a method of obtaining a luminance offset value was described in the above, hereafter, a method of obtaining a color coordinates offset value is described with reference to FIG. 3.

Referring to FIG. 3, there are four regions, for example, first to fourth cases, from desired white color coordinates in a color coordinates graph, and measured white color coordinates is shown to correspond to the second case in FIG. 3.

The case division of the color coordinates is performed by the color coordinates determining unit 224.

After the case division of the color coordinates is finished, color coordinates offset values for correcting the chromaticity in accordance with corresponding cases are set by the offset value setting unit 230, in which correction of the chromaticity may be applied in different ways according to when measured luminance is higher or lower than desired luminance. For example, the chromaticity could be corrected as in the following Table 1.

TABLE 1

| | high luminance | | | | low luminance | | | |
|---|---|---|---|---|---|---|---|---|
| | case1 | case2 | case3 | case4 | case1 | case2 | case3 | case4 |
| rR | − | | | − | | + | + | |
| gG | | − | | | | | | + |
| bB | | | − | − | + | + | | |

Therefore, for the second case shown in FIG. 3, the offset value setting unit 230 can set color coordinates offset values to decrease the chromaticity of the green color when the luminance of the panel is higher than a desired value, and increase the chromaticity of the red and blue colors when the luminance of the panel is lower than the desired value. Although these are simply shown (+) for increasing the chromaticity and (−) for decreasing the chromaticity in Table 1, the movement values for chromaticity adjustment may be predetermined within a range in view of the characteristics of the panel.

In this process, the chromaticity adjustment can be performed for each case, such that it is possible to reduce the time for adjusting the chromaticity.

Meanwhile, in the color coordinates offset value, both the reference offset value and the additional offset value can be set, such that it is possible to provide a desired image (e.g., an optimum image) corresponding to each luminance mode.

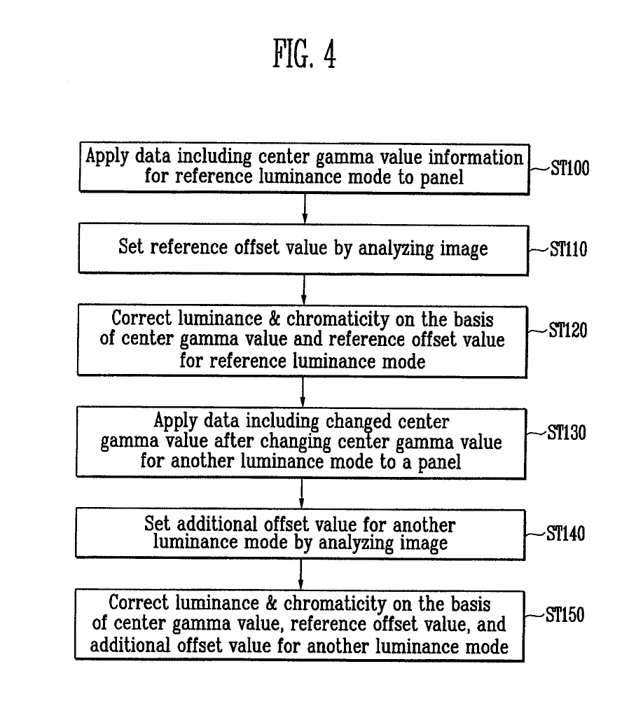

FIG. 4 is a block diagram illustrating a luminance correction method using the luminance correction system shown in FIG. 2, by stages. Referring to FIG. 4, in the first step (ST 100), the data including center gamma value information according to the reference luminance mode (e.g., first luminance mode) is applied to the panel.

In this step, it is possible for the panel to display an image having the highest luminance, e.g., full-white, by applying data having the highest gray level with the center gamma value information to the panel by the data applying unit 210.

Further, after the data having the highest gray level is applied to the panel, when another gray level data at a breakpoint appearing in the luminance curve according to another gray level, for example 31-gray level data is further applied to the panel, the panel can display an image of 31-gray level.

In step 2 (ST 110), an image of the panel is analyzed and a reference offset value is correspondingly set.

The reference offset value can include a reference offset value for luminance and a reference offset value for color coordinates. According to one embodiment, it is possible to concurrently (e.g., simultaneously) set the reference offset values for the luminance and the color coordinates by concurrently (e.g., simultaneously) analyzing the luminance and the chromaticity. However, in another embodiment, a more accurate calibration may be performed by first determining and setting the reference offset value for the luminance and then reanalyzing the image and setting the reference offset value for the color coordinates corresponding to the above reference value. This way a more accurate calibration may be performed by compensating for the distortion of the color coordinates caused by the luminance correction.

In order to achieve this operation, the step of setting a reference offset value may include: a step of measuring the luminance of an image and setting a reference offset value for the luminance; a step of measuring the chromaticity of the image after correcting the luminance, using the reference offset value for the luminance; and determining color coordinates according to the measured chromaticity and setting a reference offset value for the color coordinates.

In more detail, the step of setting a reference offset value for the luminance may include a step of comparing the measured luminance of the image with the predetermined desired luminance and a step of setting a reference offset value for the luminance according to the compared result. The compared result of the measured luminance of the image and the predetermined desired luminance can be generated according to their difference. Hence, the reference offset value for the luminance can be obtained by the corresponding difference between the measured and predetermined desired luminance values.

Further, the step of setting a reference offset value for the color coordinates may include a step of selecting one case in a plurality of cases on the basis of desired white color coordinates for predetermined color coordinates, and a step of setting a reference offset value for the color coordinates on the basis of the selected case.

In step 3 (ST 120), the luminance and chromaticity in the reference luminance mode may be corrected by applying the center gamma value for the reference luminance mode and the reference offset value.

The luminance may be corrected by adjusting the gamma value and the chromaticity may be corrected by moving the color coordinates.

In step 4 (ST 130), the center gamma value may be changed in accordance with another luminance mode (second luminance mode) and data including information on the changed center gamma value may be applied to the panel.

In step 5 (ST 140), an image of the panel may be analyzed and an additional offset value for another luminance mode may be set according to the analyzed result.

The step of setting an additional offset value may be performed in a process similar to the step of setting a reference offset value, and for example, may include: a step of measuring the luminance of an image and setting an additional offset value for the luminance; a step of measuring the chromaticity of the image after correcting the luminance, using the additional offset value for the luminance and a reference offset value (e.g., a predetermined reference value); and a step of determining color coordinates on the basis of the measured chromaticity and setting an additional offset value for the color coordinates.

In step 6 (ST 150), the luminance and chromaticity of another luminance mode may be corrected by a center gamma value for another luminance mode, a reference offset value, and an additional offset value in the luminance mode.

Meanwhile, the correction is finished, when the result of measuring the luminance or the color coordinates is the same as a desired value or within a predetermined tolerance range.

While aspects of the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A luminance correction system for a flat panel display, the luminance correction system comprising:
a data applying unit coupled to a panel of the flat panel display, and configured to apply data including center gamma value information according to a selected luminance mode from among a plurality of luminance modes to the panel;
an image analyzing unit configured to analyze an image displayed on the panel according to the data and output at least one analyzed result;
an offset value setting unit coupled to the image analyzing unit, and configured to generate a reference offset value corresponding to a center gamma value for a reference luminance mode from among the luminance modes and the at least one analyzed result, and to generate an additional offset value corresponding to the second luminance mode and the at least one analyzed result when a second luminance mode is selected from among the luminance modes; and
a data adjusting unit coupled to the offset value setting unit, and configured to adjust the data according to the reference offset value and to supply the adjusted data to the data applying unit.

2. The luminance correction system of claim 1, wherein the data adjusting unit is further configured to adjust the data according to the reference offset value, the additional offset value, and a center gamma value for the second luminance mode when the second luminance mode is selected.

3. The luminance correction system of claim 1, wherein the data applying unit is further configured to apply gray level data at a breakpoint of a luminance curve according to the gray level, together with the center gamma value information, to the panel.

4. The luminance correction system of claim 3, wherein the data applying unit is further configured to apply data corresponding to a highest gray level to the panel such that the panel emits light having a highest luminance.

5. The luminance correction system of claim 1, wherein the image analyzing unit comprises:
a measuring unit configured to measure a chromaticity and a luminance of the image;
a color coordinates determining unit configured to generate color coordinates according to the measured chromaticity; and
a luminance comparing unit configured to generate a luminance difference according to a reference luminance and the measured luminance.

6. The luminance correction system as claimed in claim 5, wherein the offset value setting unit is further configured to generate a luminance offset value according to the luminance difference and a color coordinates offset value according to the color coordinates.

7. The luminance correction system as claimed in claim 1, wherein the data adjusting unit is further configured to correct the luminance by adjusting a gamma value according to the reference offset value.

8. The luminance correction system as claimed in claim 7, wherein the image analyzing unit is further configured to analyze the chromaticity of the image after a luminance corrected image is displayed by the panel in accordance with the offset value corresponding to the analyzed result of the image.

9. The luminance correction system as claimed in claim 1, further comprising a storing unit configured to store the reference offset value and the additional offset value.

10. The luminance correction system as claimed in claim 9, wherein the storing unit is further configured to store the amount of luminance change corresponding to the result of analyzing the image.

11. A luminance correction method comprising:
applying data including center gamma value information for a first luminance mode to a panel of a flat panel display;
analyzing an image displayed on the panel and setting a reference offset value according to the analyzed result;
correcting a luminance and a chromaticity of the data in the first luminance mode according to the center gamma value for the first luminance mode and the reference offset value;
changing a center gamma value for a second luminance mode and applying data including the changed center gamma value to the panel;
analyzing an image displayed on the panel and setting an additional offset value for the second luminance mode according to the analyzed result; and
correcting a luminance and a chromaticity of the data in the second luminance mode according to the center gamma value for the second luminance mode, the reference value, and the additional offset value.

12. The luminance correction method as claimed in claim 11, wherein the data applied to the panel includes gray level data information at a breakpoint appearing in a luminance curve, together with the center gamma value information for the first or second luminance mode.

13. The luminance correction method as claimed in claim 11, wherein the setting of a reference offset value includes:
measuring the luminance of the image and setting a reference offset value for the luminance;
measuring the luminance of the image after correcting the luminance, using the reference offset value for the luminance; and
determining color coordinates on according to the measured chromaticity and setting a reference offset value for the color coordinates.

14. The luminance correction method as claimed in claim 13, wherein the setting of the reference offset value for the luminance includes:
comparing measured luminance of an image with a reference luminance; and
setting a reference offset value for luminance on the basis of the compared result.

15. The luminance correction method as claimed in claim 13, wherein the setting a reference offset value for the color coordinates includes:
selecting one case from a plurality of cases on the basis of a desired white color coordinates for the determined coordinates; and
setting a reference offset value for the color coordinates on the basis of the selected case.

16. The luminance correction method as claimed in claim 11, wherein the setting of an additional offset value includes:
measuring the luminance of the image and setting an additional offset value for the luminance;
measuring chromaticity of the image after correcting the luminance, using the additional offset value for the luminance and the reference offset value; and
determining color coordinates on the basis of the measured chromaticity and setting an additional offset value for the color coordinates.
